(19) United States
(12) Patent Application Publication
(10) Pub. No.: US 2012/0166230 A1
(43) Pub. Date: Jun. 28, 2012

(54) DYNAMIC ITEM CREATION AT POINT OF SALE

(75) Inventors: Sandy Ngo, San Francisco, CA (US); Srinivasan Venkatesan, San Francisco, CA (US); Charles Fineman, Berkeley, CA (US)

(73) Assignee: STUBHUB, INC., San Francisco, CA (US)

(21) Appl. No.: 12/979,756

(22) Filed: Dec. 28, 2010

(51) Int. Cl. G06Q 10/00; G06Q 30/00

(52) U.S. Cl. 705/5; 705/14.39

(57) ABSTRACT

A network-based system includes one or more servers that transfer to a client computer a user interface that includes a selectable icon relating to available seats for an event at an event venue and a selectable icon relating to gift certificates that are redeemable for purchasing one or more available seats to one or more events at one or more event venues. If a request for a gift certificate is received, the one or more servers receive payment for a selected monetary equivalent value for the requested gift certificate; create a gift certificate having the monetary equivalent value at the time that payment is received but not prior to receipt of the requested gift certificate, where the created gift certificate was not previously stored in any database of the network-based system; and store the created gift certificate in a database of the network-based system.

### BACKGROUND

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics. For these reasons, sellers actively use the Internet to offer, sell and distribute a wide variety of goods to take advantage of the many benefits provided by the Internet and electronic commerce.

One example of a market for goods within the realm of electronic commerce is the online ticket market. StubHub provides a network-based system which implements an online ticket marketplace for buyers and sellers of tickets for live events such as sports, concerts, theater, and other entertainment events. The StubHub online ticket marketplace enables legitimate, convenient, reliable, and secure transactions at fair market value and provides ticket fulfillment services, even for “sold out” events. Accordingly, the StubHub online ticket marketplace provides benefits for fans who wish to buy, sell or otherwise transfer tickets as well as for teams, artists, and venues.

### SUMMARY

Various embodiments are described for dynamic item creation at a point of sale. In one general aspect a network-based system includes one or more servers that transfer to a client computer a user interface that includes a selectable icon relating to available seats for an event at an event venue and a selectable icon relating to gift certificates that are redeemable for purchasing one or more available seats to one or more events at one or more event venues. If a request for a gift certificate is received, the one or more servers receive payment for a selected monetary equivalent value for the requested gift certificate; create a gift certificate having the monetary equivalent value at the time that payment is received but not prior to receipt of the requested gift certificate, where the created gift certificate was not previously stored in any database of the network-based system; and store the created gift certificate in a database of the network-based system. Other embodiments are described and claimed.

### BRIEF DESCRIPTION OF THE DRAWINGS

The foregoing aspects and many of the attendant advantages of various embodiments will become more readily appreciated and better understood by reference to the following detailed description and the accompanying drawings.

FIG. 1 is a block diagram of an exemplary communications system including a client device and a network-based system for providing an online marketplace that enables creation of items at the point of sale.

FIG. 2 illustrates a logic flow including operations performed by the network-based system of FIG. 1.

FIG. 3 illustrates a logic flow including operations performed by the client device of FIG. 1.

FIG. 4 is a screen shot of a user interface presented to a user at the client device of FIG. 1 for selecting categories.

FIG. 5 is a screen shot of a user interface presented to the user at the client device of FIG. 1 for creating an item that is a gift certificate.

FIG. 6 is a screen shot of a user interface presented to the user at the client device for creating an item that is a ticket to an event at an event venue.

FIG. 7 is a screen shot of a user interface presented to the user at the client device of FIG. 1 for enabling payment for the item to be created.

FIG. 8 is a screen shot of a user interface presented to the user at the client device of FIG. 1 for selecting delivery for the item to be created.

### DETAILED DESCRIPTION

Various embodiments are described for dynamic item creation at a point of sale. Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

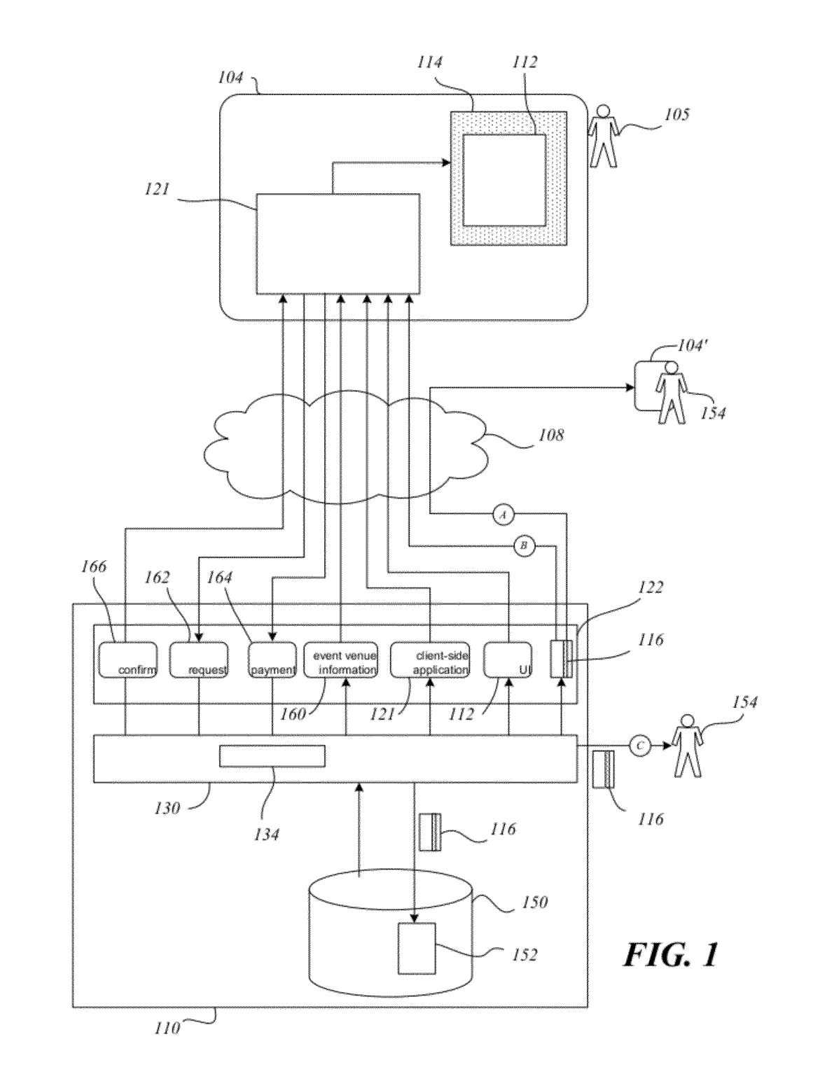

Referring to FIG. 1, a communications system 100 is shown that includes a network-based system 110 that delivers a user interface 112 to a display 114 of the client device 104 through a network 108. The user interface 112 enables a user 105 to select and configure one or more items (which can be goods or services) associated with events at one or more event venues. Additionally, the network-based system 110 receives the selection of the one or more items and creates the one or more items 116 in real time, without maintaining an inventory of the items 116. After the items 116 are created in real time, those items 116 are added to a list of sold items 152 stored in a database 150 of the network-based system 110. As described in greater detail below, in some implementations, the item 116 is a time sensitive good like a ticket to an event at an event venue, and in other implementations, the item 116 is a gift certificate that is subsequently redeemable for one or more tickets to one or more events at event venues.

The elements of the communications system 100 generally include physical or logical entities for communicating information and, in some cases, may be implemented as hardware, software, or a combination thereof, as desired for a given set of design parameters or performance constraints. Although FIG. 1 includes a limited number of elements for purposes of illustration, the communications system 100 can include more or less elements as well as other types of elements.

The client device 104 can be a mobile computing device, a personal computer (PC), and/or any other computing device having computing and/or communications capabilities. The client device also includes one or more client programs such as system programs and application programs to perform various computing and/or communications operations. Exemplary system programs include, without limitation, an operating system (for example, MICROSOFT® OS, UNIX® OS, LINUX® OS, Symbian OS™, Embedix OS, Binary Run-time Environment for Wireless (BREW) OS, Mac OS X, iOS, JavaOS, a Wireless Application Protocol (WAP) OS, and others), device drivers, programming tools, utility programs, software libraries, application programming interfaces (APIs), and so forth. Exemplary application programs include, without limitation, a web browser application, messaging applications (for example, e-mail, instant messaging or IM, SMS, MMS, telephone, voicemail, VoIP, video messaging), contacts application, calendar application, electronic document application, database application, media application (for example, music, video, television), location-based services (LBS) application (for example, GPS, mapping, directions, point-of-interest, locator), and so forth. In some usage scenarios, one or more of the client programs display various graphical user interfaces (GUIs) to present information to and/or receive information from one or more of the client devices 104.

The client device 104 provides client programs which can include a web client such as a desktop and/or mobile (e.g., WAP) web browser (such as Internet Explorer®, Mozilla®, Firefox®, Safari®, Opera®, Netscape Navigator®, etc.) capable of rendering web pages (for example, HTML documents) and supporting various browser-based web technologies and programming languages such as HTML, XHTML, CSS, Document Object Model (DOM), XML, XSLT, XMLHttpRequestObject, JavaScript, ECMAScript, Jscript, Ajax, Flash®, Silverlight™, Visual Basic® (VB), VB Scripting Edition (VBScript), PHP, ASP, Java®, Shockwave®, Python, Perl®, C#/.net, and/or others.

In one or more embodiments, the client device 104 includes a client-side web application 121 received from the network-based system 110 and installed as one or more client programs. The client-side web application 121 can be implemented as a desktop widget or mobile widget on the client device 104 to allow a user 105 at the client device 104 to receive content and/or services from the network-based system 110.

As shown, the client device 104 is communicatively coupled through the one or more networks 108 to the network-based system 110. The network-based system 110 can be structured, arranged, and/or configured to allow the client device 104 to establish one or more communications sessions with the network-based system 110 using various client programs. Accordingly, a communications session between the client device 104 and the network-based system 110 can involve the unidirectional and/or bidirectional exchange of information and can occur over one or more types of networks 108 depending on the mode of communication. While the embodiment of FIG. 1 illustrates the communications system 100 deployed in a client-server operating environment, it is to be understood that other suitable operating environments and/or architectures cam be used.

The one or more networks 108 can be the Internet, a WAN, a WWAN, a WLAN, a mobile telephone network, a landline telephone network, a VoIP network, as well as other suitable networks. For example, the client device 104 communicates with the network-based system 110 over the Internet or other suitable WAN by sending and/or receiving information via interaction with a web site, e-mail, IM session, and/or video messaging session. The client device 104 also can communicate with the network-based system 110 by way of a telephone call to a customer service agent and/or interactive voice response (IVR) system made over a mobile telephone network, a landline network, and/or a VoIP network. In wireless implementations, the client device 104 can communicate with the network-based system 110 over the Internet by way of a WLAN or mobile telephone network that supports WWAN communications services. The client device 104 also can communicate over a mobile telephone network via SMS and/or MMS messaging.

In various usage scenarios, the client device 104 uses a web client or client-side web application 121 to provide an interface (e.g., HTTP interface) for navigating to a web site associated with the network-based system 110 and for requesting and receiving web page data from the network-based system 110. For example, the client device 104 may use the web client or client-side web application 121 to navigate to a web site associated with the network-based system 110 by entering a URL into a web browser address bar and/or by clicking on a hyperlinked URL delivered to the client device 104 via a web page, web-based application, e-mail, IM, SMS, MMS, and/or other delivery mechanism.

The network-based system 110 communicates with and provides services to users such as buyers and/or sellers of items such as event tickets on a primary or secondary market or gift certificates redeemable for event tickets. For example, the network-based system 110 can include or implement an online secondary ticket marketplace for buyers and sellers of tickets for live events such as sports, concerts, theater, and other entertainment events.

Items for purchase and/or sale can include one or more of tangible goods (e.g., physical tickets, electronic tickets, physical gift certificates, electronic gift certificates), intangible goods (e.g., rights and/or licenses that are afforded by the tickets), and other goods in accordance with the described embodiments. Users other than buyers and/or sellers can communicate with the network-based system 110. In some cases, for example, the client device 104 is associated with an administrator or customer service agent and communicates with the network-based system 110 to monitor, update, and/or otherwise manage one or more computing devices and/or services of the network-based system 110.

The network-based system 110 can include or implement a plurality of servers and/or software components that operate to perform various methodologies. Exemplary servers include, for example, stand-alone and enterprise-class servers operating a server OS such as a MICROSOFT® OS, a UNIX® OS, a LINUX® OS, or other suitable server-based OS. The servers illustrated in FIG. 1 can be deployed in other ways and that the operations performed and/or the services provided by such servers can be combined or separated for a given implementation and can be performed by a greater number or fewer number of servers.

In various implementations, the servers of the network-based system 110 include or implement software components deployed in a tiered environment, where one or more servers are used to host server software running in each tier. For example, using a three-tiered architecture, one or more server software components are hosted by front-end servers, one more server software components are hosted by a middle tier or middleware implemented by application servers, and one more server software components are hosted by a back-end tier implemented by databases and/or file systems. In some embodiments, servers of the network-based system 110 are communicatively coupled with each other via a local area network (LAN) and/or suitable intranet or back-end network.

The network-based system 110 can include one or more communications servers for providing suitable interfaces to enable communication using various modes of communication and/or via one or more networks 108. In the embodiment of FIG. 1, the communications servers include a web server 122 and other servers such as an API server (not shown) and a messaging server (not shown) to provide interfaces to one or more application servers 130. In various scenarios, the client device 104 communicates with applications servers 130 of the network-based system 110 via one or more of a web interface provided by the web server 122, a programmatic interface provided by the API server, and a messaging interface provided by the messaging server. In FIG. 1, for simplicity, only the web server 122 is shown. It can be appreciated that the web server 122, the API server, and the messaging server can be structured, arranged, and/or configured to communicate with various types of client devices 104 and/or client programs and can interoperate with each other in some implementations.

The web server 122 can be arranged to host web pages (for example, HTML documents) and provide an appropriate web interface (for example, HTTP, CGI, etc.) for enabling data to be presented to and received from entities via the Internet. The web server 122 can be arranged to communicate with web clients and/or applications such as a web browser, web browser toolbar, desktop widget, mobile widget, web-based application, web-based interpreter, virtual machine, and so forth. The web server 122 can provide a web interface to enable access by the client device 104 to the various services and functions provided by the application servers 130. For example, the web server 122 can be arranged to receive data from the client device 104 and to pass the data to the one or more application servers 130 within the network-based system 110. The web server 122 also can present the client device 104 with relevant static and dynamic content hosted by the network-based system 110 in response to various requests and/or events.

The application servers 130 of the network-based system 110 can be structured, arranged, and/or configured to provide various online marketplace and/or ticket fulfillment services to users that access the network-based system 110. When implemented as an online ticket marketplace, the application servers 130 of the network-based system 110 can provide various online marketplace and ticket fulfillment services including, for example, account services, buying services, selling services, listing catalog services, dynamic content management services, delivery services, payment services, and notification services. Though not all shown in FIG. 1, the application servers 130 include an account server, a buying server 134, a selling server, a listing catalog server, a dynamic content management server, a delivery server, a payment server, and a notification server, structured and arranged to provide such online marketplace and ticket fulfillment services.

The application servers 130, in turn, can be coupled to and capable of accessing one or more databases 150 including a subscriber database, an active events database, and a transaction database. The databases 150 generally can store and maintain various types of information for use by the application servers 130 and can include or be implemented by various types of computer storage devices (for example, servers, memory) and/or database structures (for example, relational, object-oriented, hierarchical, dimensional, network).

The buying server 134 implemented by one or more of the application servers 130 allows a user to locate goods offered for sale via an online marketplace provided by the network-based system 110. To find goods for sale such as a single or multiple event tickets, a buyer may view active event listing published by the network-based system 110.

For example, the buyer can browse active event listings by clicking and following links for various event categories and subcategories such as sports tickets, concert tickets, theater tickets, cities, sports, teams, artists, show type (for example, Broadway, opera, ballet, comedy), event names, and so forth. The buyer also can search for events using a search engine interface and/or one or more pull-down menus. For example, the buyer enters one or more keywords into a search engine text entry box and views results including active events that satisfy the query. In various implementations, the buyer is presented with a ticket finder screen including a plurality of pull-down menus for allowing the buyer to quickly formulate a search by selecting a category (for example, sports, concert, theater, etc.), a location (for example, city), and a number of tickets from the pull-down menus.

Once a buyer has located and selected an event, the tickets being offered for sale for the event may be presented to the buyer. In various embodiments, the user views the details of tickets being offered for sale and the location of tickets in the event venue. The buyer is presented with an interactive event venue seat map and details of available tickets according to criteria specified by the buyer.

In one implementation, for example, after selecting an event, the buyer is presented with an interactive event venue seat map and an initial listing of all event tickets for sale. The event listings can include details such as section, row, quantity, and price and can be sorted by the buyer according to such details. The sections of the interactive event venue seat map for which tickets are available can be displayed in color while sections having no available tickets may be displayed in white. The interactive event venue may be implemented as described in U.S. patent application Ser. No. 12/544,615, titled “System and Methods for Mapping Price and Location of Tickets in an Event Venue,” which was filed on Aug. 20, 2009 and is incorporated by reference in its entirety.

Within the interactive event venue seat map, comparable or similarly-located (for example, upper level) sections having available tickets can be displayed in the same color while sections having available tickets that are not comparable or similarly-located can be displayed in different colors. For example, the colors used in the sections can correspond to zones for the sections with each zone having several comparable or similarly-located sections. Along with the interactive event venue seat map, the buyer can be presented with a list having the different zone names and the color used for each zone. The names of zones having available tickets can be displayed in black text, while the names of zones having no available tickets can be displayed in gray text.

When presented with the interactive event venue seat map, the buyer rolls over a particular section, which can cause a roll-over screen to appear indicating the quantity and price range of tickets available in that section. By clicking on a particular section, the event listings can be filtered to display only the event listings in the selected section along with the specific details (for example, section, row, quantity, price) for such tickets. The buyer also can zoom-in, zoom-out, drag, and/or rotate the interactive event venue seat map.

When presented with the initial listing of all event tickets for sale, the buyer can filter the initial listing by inputting criteria such as one or more price ranges (for example, $75-$286, $286-$349, $349-$442, $442-$559, and $559 and up). Once the buyer selects a price range, the event listings are filtered to display only the event listings in the selected price range. Additionally, the interactive event venue seat map is modified to display sections in color for which tickets are available in the selected price range.

Each event listing can include ticket attributes such as section, row, quantity, and price. Each listing also can include a link to view additional details that, when clicked, display the ticket attributes along with further ticket details (for example, seat numbers, time remaining to purchase the tickets, seller comments, delivery options), a selectively enlargeable image of the event venue for reviewing the location of the seats, and an action button for initiating purchase of the tickets.

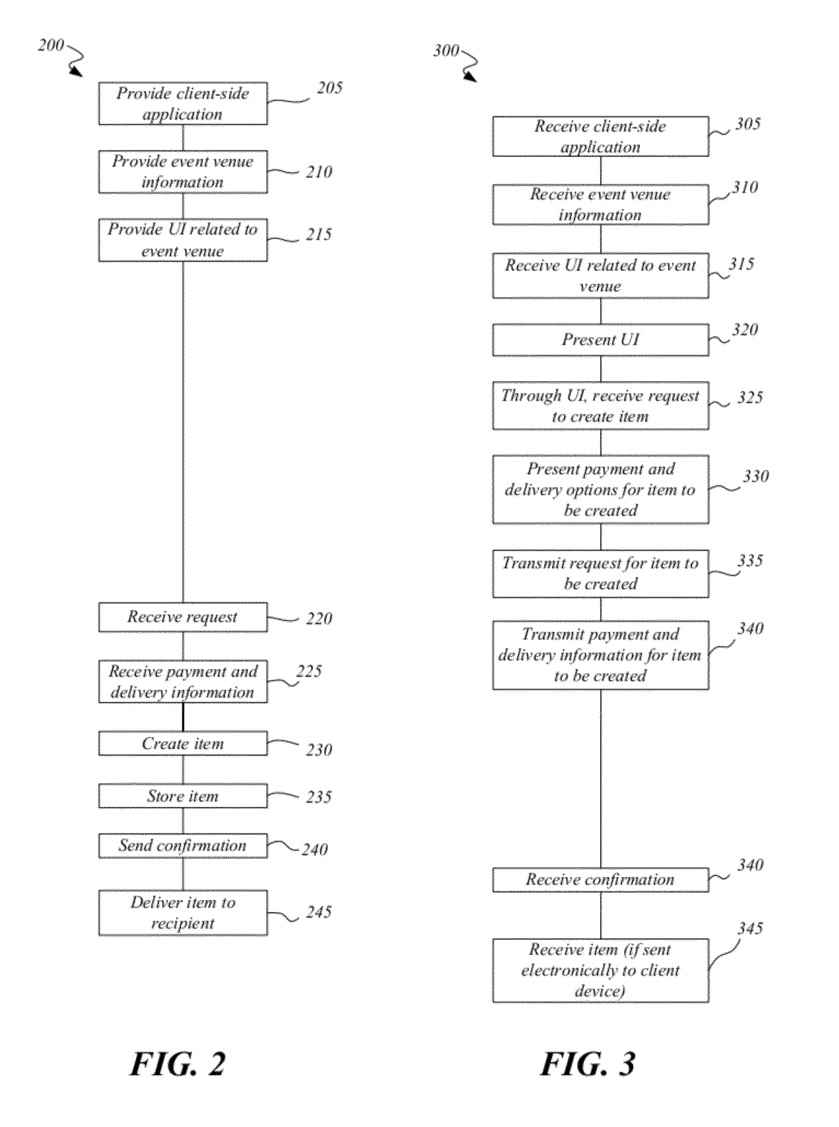

Referring to FIG. 2, a logic flow 200 includes operations performed by the network-based system 110 for interacting with the client device 104 to provide a mechanism with which to receive requests for items (such as tickets and/or gift certificates) and to create the items based on the requests. The network-based system 110 can provide the client-side web application 121 to the client device 104 through the network (step 205). Additionally, the network-based system 110 provides information 160 about one or more event venues to the client device 104 (step 210). The information 160 about the one or more event venues includes, for example, a map of the event venue, available seats to events at the event venue, a size of the event venue, and a location of the event venue. Therefore, the information 160 can be based on previously-sold tickets to one or more events at the event venue since the available seats to an event would be determined based on the previously-sold tickets to the event. The network-based system 110 also provides the user interface 112 in which to present the information 160 at the client device 104 and in which to enable the user 105 at the client device 104 to review the event venue information, among other information (step 215).

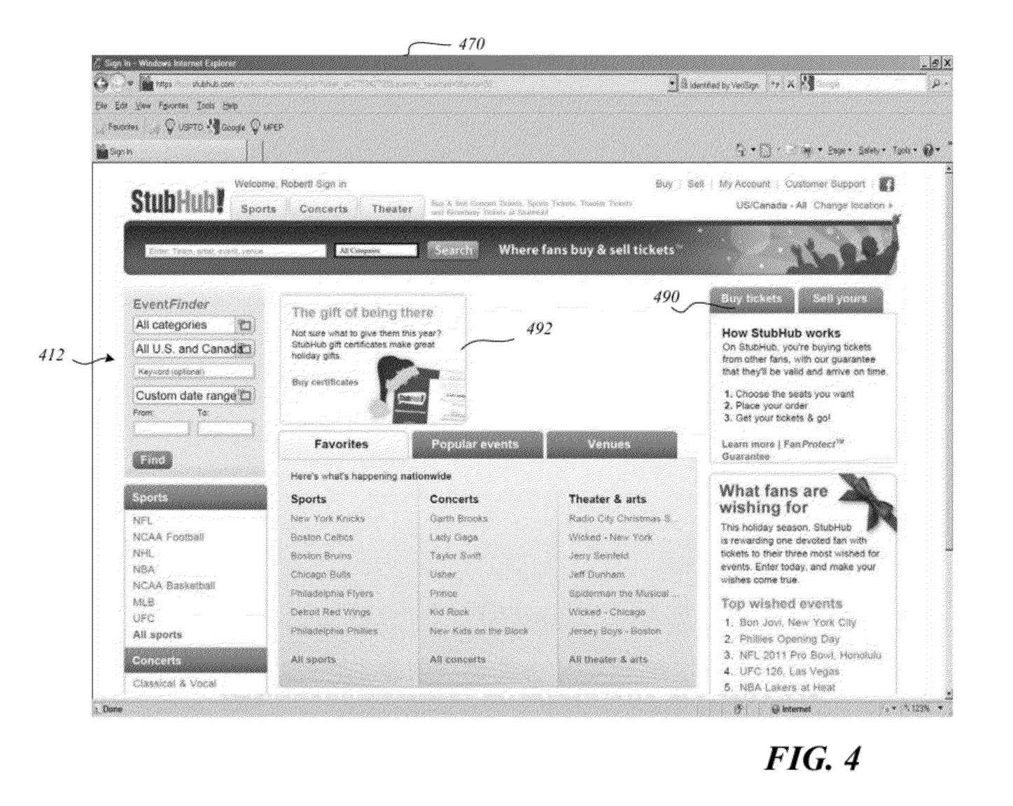

Referring to FIG. 3, a logic flow 300 includes operations performed by the client device 104 in parallel with the operations performed by the network-based system 110. Thus, the client device 104 receives the client-side web application 121 (step 305) from the network-based system 110 if it is provided at step 205. The client device 104 receives the event venue information 160 (step 310) from the network-based system 110 and the client device 104 receives the user interface 112 (step 315) from the network-based system 110.

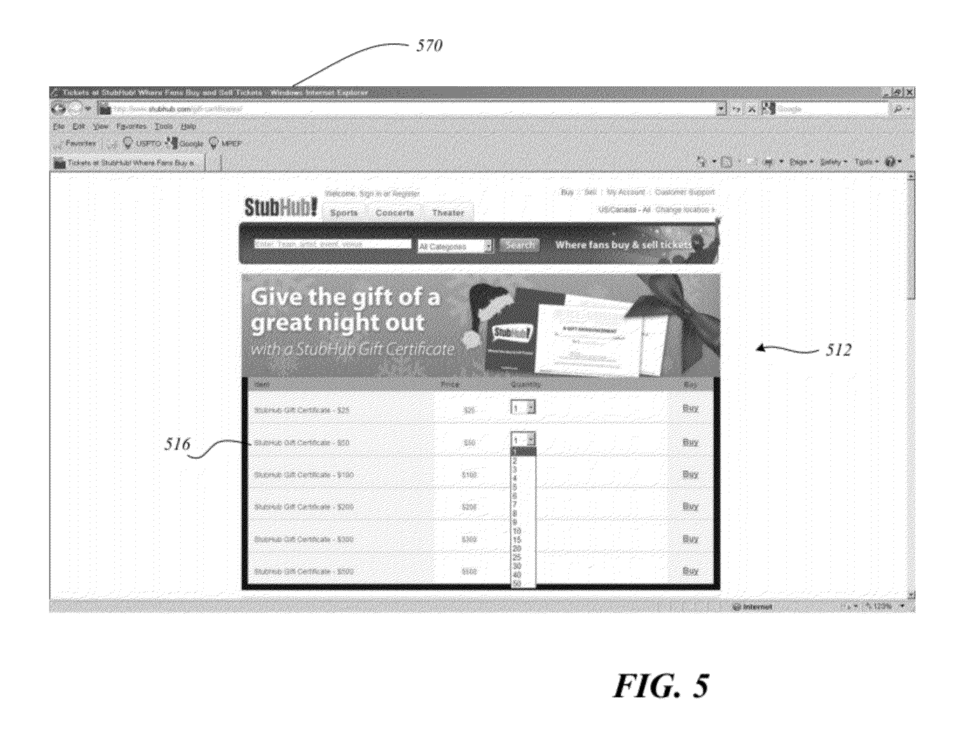

At this time, the following actions in the communications system 100 are generally performed by the client device 104 in the procedure 300. Namely, the client device 104 presents the user interface 112 in a web browser on the display 114 (step 320). Referring also to FIG. 4, an exemplary user interface 412 in a web browser 470 enables a user to select a category 490 related to available seats for an event at an event venue and also enables a user to select a category 492 related to configuring and purchasing gift certificates that are redeemable for purchasing one or more available seats to one or more events at one or more event venues associated with the network-based system 110.

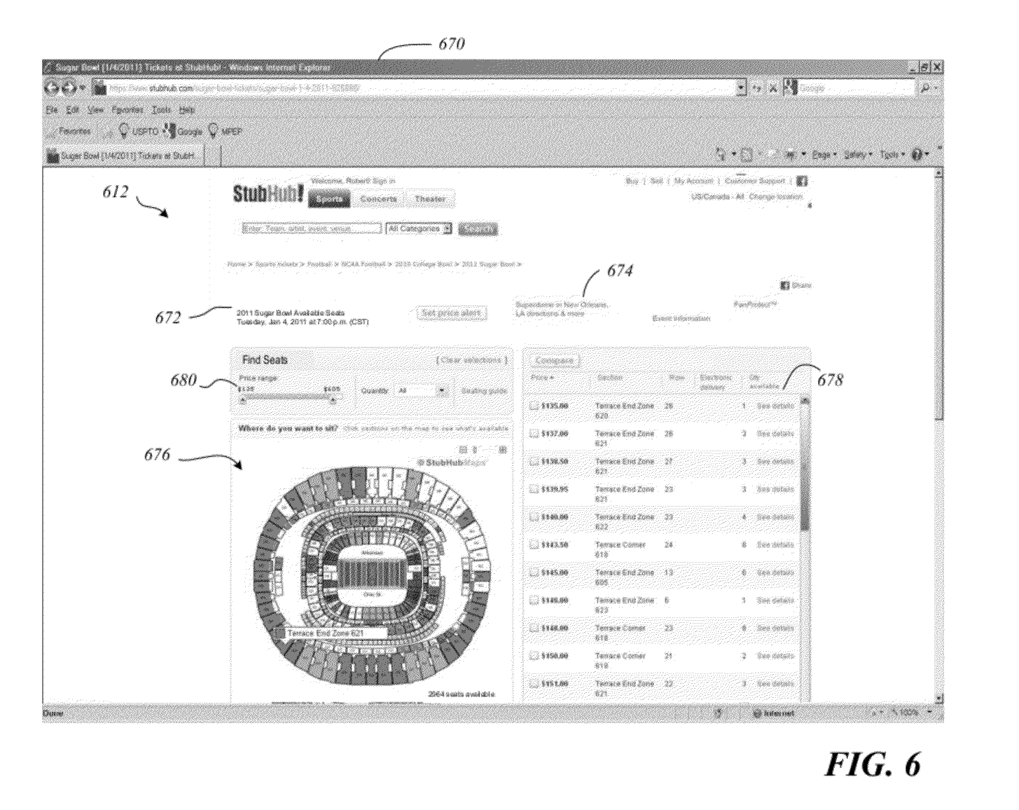

Next, as shown in FIG. 5, if a user selects within the user interface 412 the category 492 for configuring and purchasing a gift certificate, another exemplary user interface 512 is presented in a web browser 570 on the display 114 for enabling the selection and configuration of gift certificates at the client device 104.

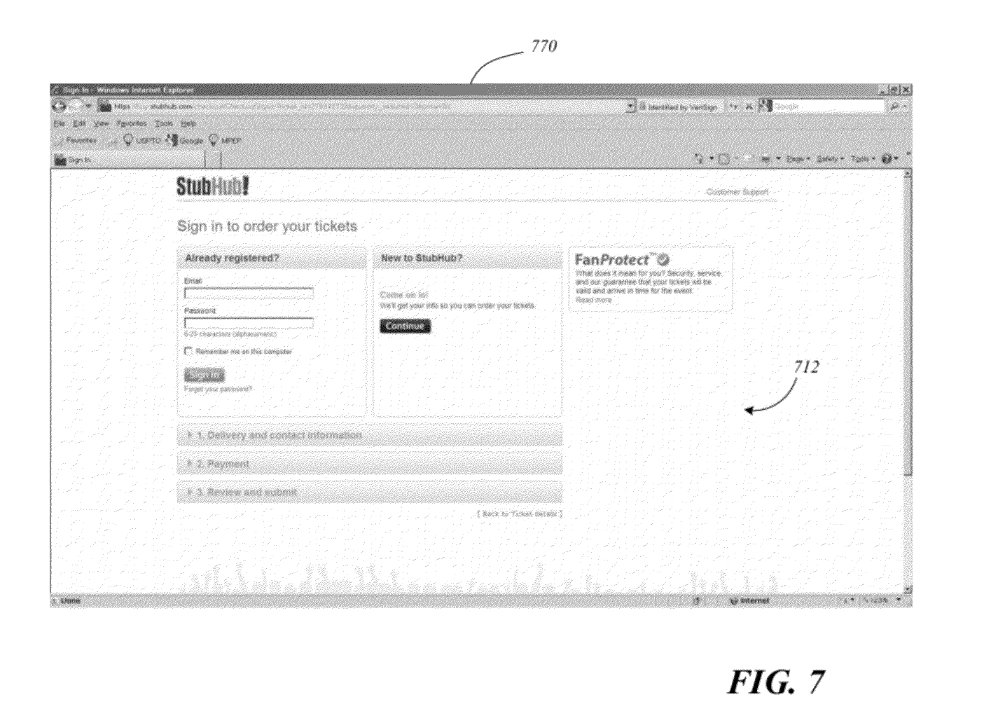

On the other hand, as shown in FIG. 6, if a user selected within the user interface 412 the category 490 for available seats for events, then another exemplary user interface 612 is presented in a web browser 670 on the display 114 for enabling the selection of seats at an event in an event venue and the configuration of tickets for the selected seats. In general, if the user is interested in seats to an event, then the user interface provides one or more mechanisms in which a user can enter event data, section, row, seats, and event description.

The client device 104 receives a request from the user 105 through the user interface 112 to create an item for purchase (step 325), the item being related to the one or more event venues associated with the network-based system 110. A gift certificate is related to event venues associated with the network-based system 110 since the gift certificate is only redeemable for tickets to events at the event venues associated with the network-based system 110.

Thus, in the example of FIG. 5, the user 105 can request as an item 116 a gift certificate 416 that is subsequently redeemable for one or more tickets to one or more events at event venues through the network-based system 110. The user 105 configures the gift certificate 516 by entering an amount, for example, in a text box, or, as shown in FIG. 5, by selecting available amounts from a set of available amount options presented in the user interface 512. The gift certificate 516 is not in existence (that is, it is not stored in a list of items sold within a database of the network-based system 110) at the time that the user 105 configures the gift certificate 516.

In the example of FIG. 6, the user 105 can request as an item 116 a ticket to an event 672 at the event venue 674 shown in the user interface 612, the ticket being for a seat at the event 672 within the event venue 674 that has been selected by the user 105. The user 105 configures the ticket by selecting a section of the event venue 674 and a price to pay for the ticket. The ticket is not in existence at the time that the user 105 configures the ticket. In this example, the user 105 can select a section of the event venue 674 by clicking on a section on an interactive seat map 676 or by scrolling through a list 678 of sections within the event venue 674 that have available seats. The user 105 could, alternatively or additionally, enter a monetary range for the price the user is willing to pay for each ticket and the user interface 612, via the network-based system 110) can present a list of sections for which seats are available in the monetary range entered by the user 105.

After the client device 104 receives the request to create the item (step 325), the client device 104 presents payment and delivery options for the item 116 to be created through the user interface 112 (step 330). The buyer (or user 105 at the client device 104) can provide a delivery location, select a method of payment (for example, credit card), confirm the transaction details (for example, description of the tickets, delivery method, delivery location, payment amount, and method of payment), and then complete the purchase.

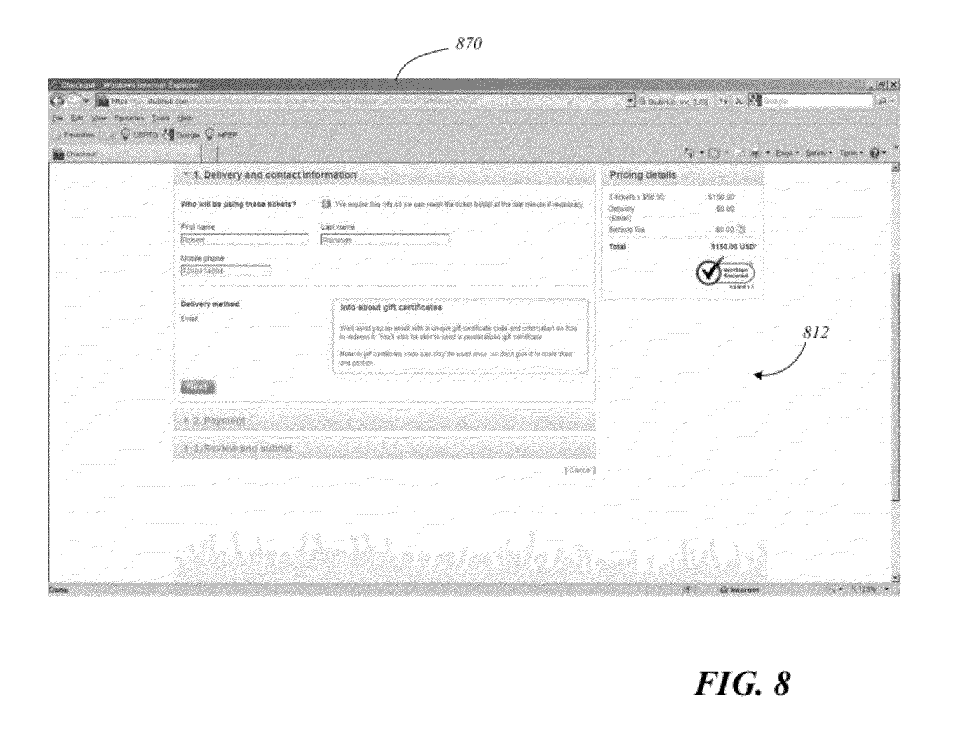

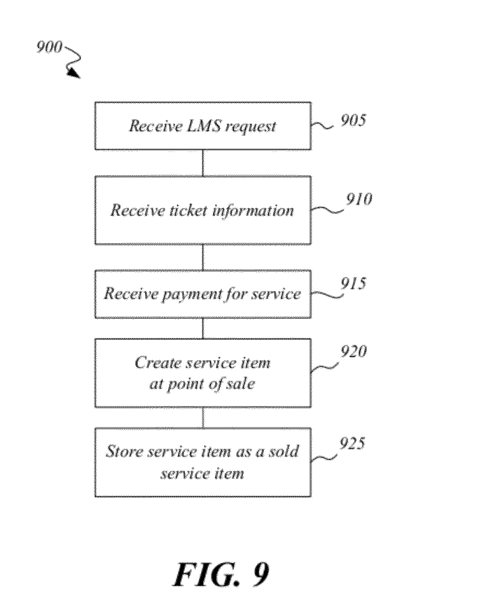

When the buyer places the order, a confirmation e-mail can be sent to the buyer. For example, as shown in FIG. 7, a payment user interface 712 is displayed in the browser 770 and as shown in FIG. 8, a delivery user interface 812 is displayed in the browser 870.

The client device 104 transmits the request 162 (see FIG. 1) for the item to be created to the network-based system 110 through the network 108 (step 335) and transmits the payment and delivery information 164 (see FIG. 1) for the item to be created to the network-based system 110 through the network 108 (step 340). The client device 104 also receives a confirmation 166 (see FIG. 1) from the network-based system 110 indicating that the item has been created and the payment has been received (step 345). And, if the buyer 105 is the recipient of the item 116, then the client device 104 receives the item 116 from the network-based system 110 (step 350).

Referring again to FIG. 2, the network-based system 110 receives the request 162 from the client device 104 (step 220) and receives the payment and delivery information 164 from the client device 104 (step 225). If the request 162 is for a gift certificate, then the request 162 includes a monetary equivalent value associated with the gift certificate. If the request 162 is for tickets to an event at an event venue, then the request 162 includes information regarding the sections and/or seats at which tickets are to be created along with prices for each of the seats. The network-based system 110 can also determine if the request received at step 325 relates to seats at an event whether the request matches with an available event and seat at an event venue for the event. In response to the information contained in the request 162, the network-based system 110 creates the item 116 (step 230). The network-based system 110 creates the item 116 by creating an electronic file associated with the request, the electronic file including a unique identification number along with information about price (for example, the monetary equivalent value or the ticket price), and then stores the information about the item 116 in a list 152 of items sold within the database 150 (step 235).

The network-based system 110 can create the item 116 (step 230) immediately after receiving payment at step 225 or immediately after receiving the request 162 (step 225).

The network-based system 110 sends the confirmation 166 to the client device 104 (step 240) and then delivers the item 116 (which can be an electronic file) through the network 108 to a recipient 154 at another client device 104′ along the path labeled A (step 245). In other implementations, the recipient 154 is the buyer 105 at the client device 104 and the item 116 is delivered through the network 108 to the buyer 105 along the path labeled B. In other implementations, the network-based system 110 creates a hard copy of the item 116 and delivers the hard copy of the item 116 through the postal mail to a recipient 154 along the path labeled C.

After the item 116 is created and is added to the list 152 of sold items (step 235), and if the item is a ticket to an event at an event venue, then the information associated with the event venue for which the ticket was sold must be updated to reflect only those seats which are still available. Thus, seats for which tickets have been created are removed from the list of available seats.

It is to be understood that while particular user interfaces may be described as comprising a certain set of features and functions, a user interface may comprise fewer features and functions, additional features and functions, and/or a combination of various features and functions of different user interfaces in accordance with the described embodiments.

It is also to be understood that the embodiments are not limited to the context of buyers and that an item may be a service. For example, the network-based system 110 may provide sellers and buyers with various last minute services (LMS) for delivering purchased tickets. In various implementations, when a seller or broker requires delivery of physical tickets for an upcoming event, the seller or broker may select to sell the tickets using LMS provided by the network-based system 110. The seller or broker may request LMS and provide the network-based system 110 with contact information (e.g., name, address, telephone number, e-mail address), ticket information (e.g., event name, event venue, ticket event dates, closest city to the event), and authorization to release the tickets. Information about the person who will be picking up the tickets also may be provided to and collected by the network-based system 110.

Depending on the time remaining before the event, the seller or broker may be instructed to ship or physically deliver the tickets to an LMS center associated with the network-based system 110. Typically, the location of the LMS center will be in close proximity to the event venue. The seller or broker also may select to physically deliver the tickets to the LMS center. When physical delivery of the ticket to the LMS center is required or selected, the seller or broker may be provided with the location of the LMS center, driving or walking directions to the LMS center, and/or a map showing the LMS center.

Once the tickets are received at the LMS center, subsequent delivery of the tickets to a buyer is handled by the network-based system 110. For example, the LMS center and/or the network-based system 110 may handle the responsibility of shipping the tickets to the buyer, delivering the tickets to the event venue will call, and/or the keeping the tickets at the LMS center until pick up by the buyer.

In some embodiments, the network-based system 110 may allow brokers to use the pick-up services of the network-based 110 system for a fee. Accordingly, a seller or broker may select to use the pick-up services of the network-based system 110 and provide the network-based system 110 with the details of tickets that have been sold by the seller or broker and information and instructions about the clients of the seller or broker who purchased the tickets. In such embodiments, the network-based system 110 receives payment for the service and creates a service item by creating an electronic file associated with the LMS request. The electronic file may include, for example, a unique identification number along with information about the tickets (e.g., event name, event venue, section, row, etc.), the broker, and the client of the broker who will be picking up the tickets. The network-based system 110 may create the service item at the point of sale at the time payment is received from the broker and store the information about the service item in a list of items sold within the database 150.

Referring to FIG. 9, a logic flow 900 includes operations performed by the network-based system 110 for providing last minute services (LMS) to a broker. The network-based system 110 receives a LMS request from the broker (step 905), receives ticket information (e.g., event name, event venue, section, and row) for tickets sold by the broker (step 910), and receives payment from the broker for holding the tickets sold by the broker for pick up by a client of the broker (step 915). The network-based system 110 creates a service item at the point of sale at the time that payment is received from the broker (step 920) and stores the service item in a database of the network-based system as a sold service item (step 925).

It can be appreciated that while a logic flow may illustrate a certain sequence of steps, other sequences of steps may also be performed in accordance with the described embodiments. Moreover, some individual steps of the logic flow may include multiple sub-steps that may be performed in various sequences as appropriate to the individual step. Furthermore, additional steps may be added or some steps may be removed depending on the particular implementation.

In various embodiments, one or more operations of a logic flow may comprise, or be implemented as, executable computer program instructions. The executable computer program instructions may be implemented by software, a software module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable programming language in accordance with the described embodiments.

In various embodiments, one or more operations of a logic flow may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage include random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, and other suitable types of computer-readable storage media in accordance with the described embodiments.

Although some embodiments may be illustrated and described as comprising exemplary functional components or modules performing various operations, it can be appreciated that such components or modules may be implemented by one or more hardware components, software components, firmware components, and/or combination thereof.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A method comprising:
transferring, from a network-based system to a client computer, information associated with one or more event venues;
transferring, from the network-based system to the client computer, a user interface that enables a user selection of a category related to available seats for an event at an event venue and a user selection of a category related to gift certificates that are redeemable for purchasing one or more available seats to one or more events at the one or more event venues; and
if a request for a gift certificate has been received at the network-based system from the client computer:
receiving, at the network-based system, payment for monetary equivalent value for the requested gift certificate from the client computer;
creating, at the network-based system, a gift certificate having the monetary equivalent value at the time that payment is received but not prior to receipt of the requested gift certificate, where the created gift certificate was not previously stored in a database of the network-based system;
storing the created gift certificate in a database of the network-based system as a sold gift certificate; and
transferring the sold gift certificate from the network-based system to a recipient.

2. The method of claim 1, wherein transferring information associated with the event venue comprises transferring an interactive seat map showing seats available for the event at the venue.

3. The method of claim 1, wherein creating the gift certificate at the time that payment is received comprises creating the gift certificate immediately after payment for the requested selected monetary equivalent value is received.

4. The method of claim 1, wherein creating the gift certificate at the time that payment is received comprises creating the gift certificate immediately after the request for the gift certificate is received.

5. The method of claim 1, wherein transferring each of the sold gift certificates to the recipient comprises sending the gift certificates as electronic gift certificates to the recipient through a network to which the network-based system is connected.

6. The method of claim 1, wherein transferring each of the sold gift certificates to the recipient comprises sending a hard copy of the gift certificates through postal mail to the recipient.

7. The method of claim 1, wherein creating the gift certificate comprises creating a hard copy of the gift certificate.

8. The method of claim 1, wherein creating the gift certificate comprises creating an electronic copy of the gift certificate.

9. The method of claim 1, further comprising storing information about one or more event venues within a database of a network-based system.

10. The method of claim 1, further comprising providing the client computer with a client-side web application configured to communicate with the network-based system.

11. The method of claim 1, further comprising if a request for one or more available seats for an event at an event venue is received at the network-based system from the client computer:
receiving, at the network-based system, payment for the one or more requested seats from the client computer;
creating, at the network-based system, a ticket for each of the one or more requested seats at the time that payment is received but not prior to receipt of the one or more requested seats, where the created ticket was not previously stored in a database of the network-based system;
storing each created ticket in the database of the network-based system as a sold ticket; and
transferring each of the sold tickets from the network-based system to a recipient.

12. The method of claim 11, wherein creating the ticket for each of the one or more requested seats at the time that payment is received comprises creating the ticket immediately after payment for the requested available seats is received.

13. The method of claim 11, wherein creating the ticket for each of the one or more requested seats at the time that payment is received comprises creating the ticket immediately after the request for the one or more available seats is received.

14. The method of claim 11, further comprising updating information associated with the event venue including available seats for the event at the event venue after the ticket for each of the one or more requested seats is created to remove the seats corresponding to the created tickets from the list of available seats stored in the database.

15. The method of claim 11, wherein transferring each of the sold tickets to the recipient comprises sending the sold tickets as electronic tickets to the recipient through a network.

16. The method of claim 11, wherein transferring each of the sold tickets to the recipient comprises sending the sold tickets to the recipient through postal mail.

17. The method of claim 11, wherein creating the ticket for each of the requested seats comprises creating one or more of a hard copy of the ticket and an electronic ticket.

18. A computer-readable storage medium comprising executable computer program instructions that, when executed, cause a computer system to:
transfer to a client computer a user interface that includes a selectable icon relating to available seats for an event at an event venue and a selectable icon relating to gift certificates that are redeemable for purchasing one or more available seats to one or more events at one or more event venues; and
if a request for a gift certificate is received from the client computer:
receive payment for a selected monetary equivalent value for the requested gift certificate from the client computer;
create a gift certificate having the monetary equivalent value at the time that payment is received but not prior to receipt of the requested gift certificate, where the created gift certificate was not previously stored in any database of the computer system;
store the created gift certificate in the database as a sold gift certificate; and
transfer the sold gift certificate to a recipient.

19. The computer-readable storage medium of claim 18, further storing executable program instructions that, when executed, cause the computer system to:
if a request for one or more available seats for an event at an event venue is received from the client computer:
receive payment for the one or more requested seats from the client computer;
create a ticket for each of the one or more requested seats at the time that payment is received but not prior to receipt of the one or more requested seats, where the created ticket was not previously stored in any database of the computer system;
store each created ticket in the database as a sold ticket; and
transfer each of the sold tickets to a recipient.

20. A method comprising:
receiving, at a network-based system from a broker, ticket information including event name, event venue, section, and row for tickets sold by the broker and payment from the broker for holding the tickets sold by the broker for pick up by a client of the broker;
creating, at the network-based system, a service item at the time that payment is received from the broker; and
storing the service item in a database of the network-based system as a sold service item.
